(19) United States
(12) Patent Application Publication
(10) Pub. No.: US 2014/0308843 A1
(43) Pub. Date: Oct. 16, 2014

(54) CONNECTOR ASSEMBLY

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: ZHI-MING ZHU, Wuhan (CN); TING WANG, Wuhan (CN); DAN YU, Wuhan (CN); YAN-NI TANG, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/093,118

(22) Filed: Nov. 29, 2013

(30) Foreign Application Priority Data
Apr. 11, 2013 (CN) 2013101248052

(51) Int. Cl. H01R 13/642

(52) U.S. Cl. CPC H01R 13/642
USPC 439/374

(57) ABSTRACT

A connector assembly includes a socket connector and a plug connector. The socket connector includes a first top plate and a second top plate. The plug connector includes a first bottom wall and a second bottom wall. The first top plate corresponds to the first bottom wall, and the second top plate corresponds to the second bottom wall. When the connector assembly is correctly assembled, pins extending from the plug connector are allowed to be fully received into inserting slots defined in the socket connector. When the connector assembly is incorrectly assembled, the first top plate abuts against the second bottom wall, blocking the pins from being fully received into the inserting slots.

### REARGROUND

1. Technical Field

The present disclosure relates to connector assemblies, and particularly to a connector assembly with a user friendly mechanism.

2. Description of Related Art

A connector assembly is used for transmitting data between two electronic devices. The connector assembly includes a socket connector defining a plurality of inserting slots and a plug connector forming a plurality of plugs. Each plug is received into a corresponding inserting slot. However, it is easy to insert a plug into a wrong inserting slot. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a connector assembly.

FIG. 2 is similar to FIG. 1, but viewed from another angle.

FIG. 3 is an assembled, isometric view of the connector assembly of FIG. 1 when the connector assembly is correctly assembled.

FIG. 4 is an assembled, isometric view of the connector assembly of FIG. 1 when the connector assembly is incorrectly assembled.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

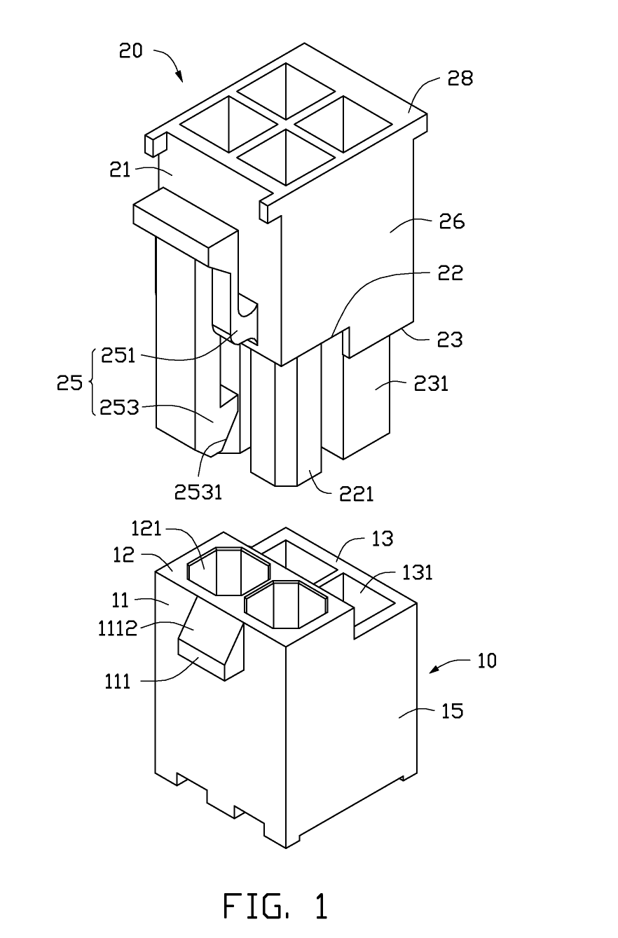

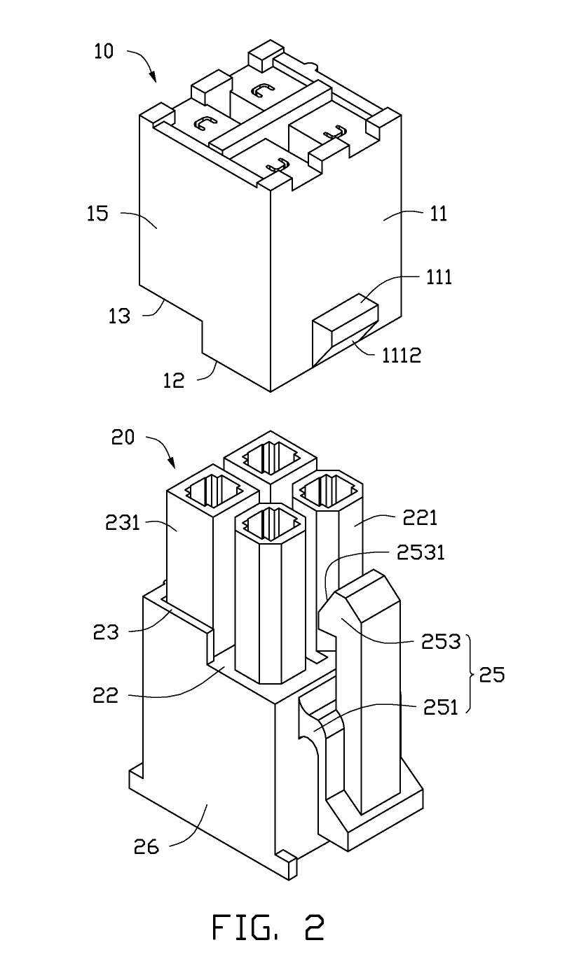

FIG. 1 and FIG. 2 show one embodiment of a connector assembly including a socket connector 10 and a plug connector 20.

The socket connector 10 includes a front plate 11, a stepped top portion (not labeled), and three side plates 15. The stepped top portion includes a first top plate 12 and a second top plate 13. A positioning portion 111 extends from the front plate 11 and includes a sliding plane 1112. The sliding plane 1112 extends downwards from the meeting end and rises from the front plate 11. An acute angle between the sliding plane 1112 and the front top plate 12. The front plate 11 and the three side plates 15 cooperatively form a substantially cuboid structure. In one embodiment, the first top plate 12 is substantially parallel to the second top plate 13. A distance between the first top plate 12 and a bottom of the socket connector 10 is greater than a distance between the second top plate 13 and the bottom of the socket connector 10. The socket connector 10 defines two first inserting slots 121 in the first top plate 12, and two second inserting slots 131 in the second top plate 13. A depth of each first inserting slot 121 is greater than a depth of each second inserting slot 131. In one embodiment, a cross-section of each first inserting slot 121 is substantially octagonal, and a cross-section of each second inserting slot 131 is substantially rectangular.

The plug connector 20 includes a front wall 21, a stepped bottom portion (not labeled), three sidewalls 26, a top wall 28, and a latch 25. The stepped bottom portion includes a first bottom wall 22 and a second bottom wall 23. The front wall 21 and the three sidewalls 26 cooperatively form a substantially cuboid structure. In one embodiment, the front wall 21 is substantially perpendicular to the top wall 28, and the top wall 28 is substantially parallel to the first bottom wall 22 and the second bottom wall 23. A distance between the first bottom wall 22 and the top wall 28 is less than a distance between the second bottom wall 23 and the top wall 28. A distance between the first bottom wall 22 and the second bottom wall 23 is substantially equal to a distance between the first top plate 12 and the second top plate 13. Two first pins 221 extend from the first bottom wall 22 and correspond to the two first inserting slots 121. Two second pins 231 extend from the second bottom wall 23 and correspond to the two second inserting slots 131. A height of each first pin 221 is greater than a height of each second pin 231. A height difference between the first pin 221 and the second pin 231 is substantially equal to a height difference between the first inserting slot 121 and the second inserting slot 131, and also substantially equal to a height difference between the first bottom wall 22 and the second bottom wall 23. In one embodiment, a cross-section of each first pin 221 is substantially octagonal, and a cross-section of each second pin 231 is substantially rectangular. The latch 25 extends from the front wall 21 and includes a maintaining portion 251 and a hooked latching portion 253 connected to the maintaining portion 251. The maintaining portion 251 is connected to the front wall 21. The latching portion 253 extends out of the first bottom wall 22 and the second bottom wall 23 and includes a latching plane 2531. The latching plane 2531 is oblique, and an acute angle is defined between the latching plane 2531 and the front wall 21, and the latching plane 2531 is on an inner surface of the latch 25 at the distal end thereof.

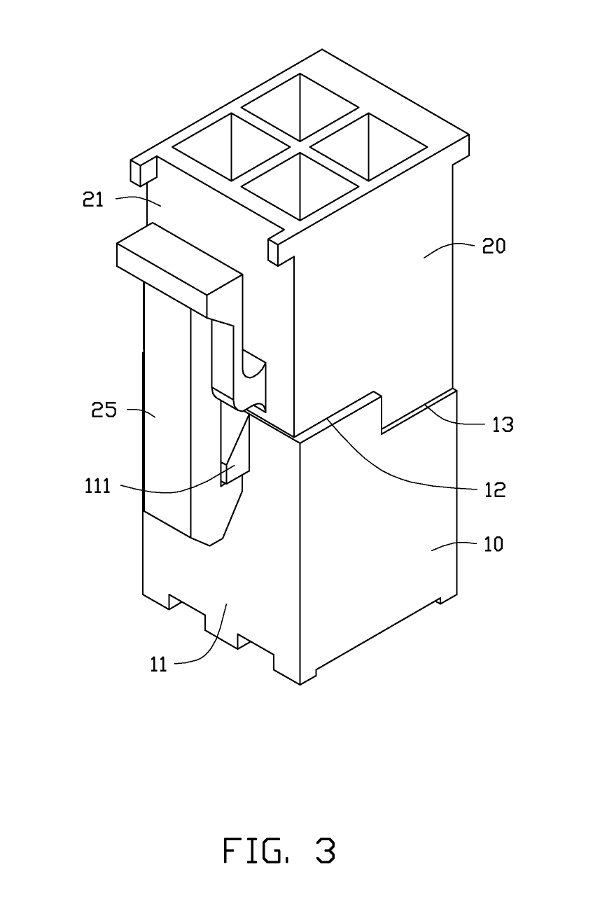

Referring to FIG. 3, in assembly, the latch 25 is aligned with the positioning portion 111, the first pins 221 are aligned with the first inserting slots 121, the second pins 231 are aligned with the second inserting slots 131, the first top plate 12 faces the first bottom wall 22, and the second top plate 13 faces the second bottom wall 23. The first pins 221 are received into the first inserting slots 121, and the second pins 231 are received into the second inserting slots 131, until the latching portion 253 abuts the sliding plane 1112. The plug connector 20 is further pushed toward the socket connector 10 to elastically deform the latch 25, so that the latching plane 2531 slides along the sliding plane 1112. The latching plane 2531 continues to slide along the sliding plane 1112 until the latching portion 253 slides over the positioning portion 111. When the first top plate 12 and the second top plate 13 abut the first bottom wall 22 and the second bottom wall 23, respectively, each first pin 221 is fully received into the corresponding first inserting slot 121, and each second pin 231 is fully received into the corresponding second inserting slot 131.

In disassembly, the latch 25 is pulled out to disengage from the positioning portion 111, and the plug connector 20 is removed from the socket connector 10.

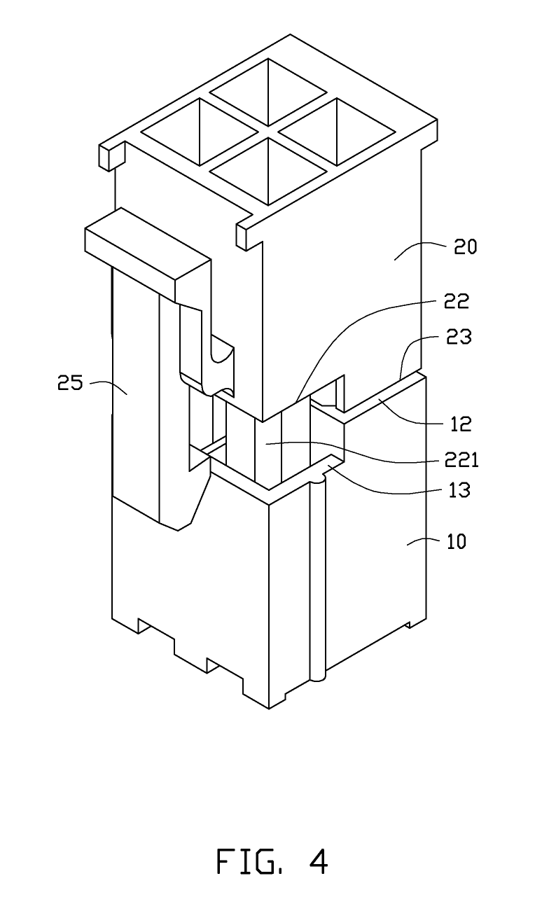

FIG. 4 shows a result of incorrectly connecting the plug connector 20 to the socket connector 10. The plug connector 20 is turned to align a first pin 221 and a second pin 231 with a second inserting slot 131 and a first inserting slot 121, respectively. The first top plate 12 faces the second bottom wall 23, and the second top plate 13 faces the first bottom wall 22. When the plug connector 20 is pushed towards the socket connector 10, the first top plate 12 abuts the second bottom wall 23 to block the plug connector 20 from being pushed further. Thus, the first pins 221 are prevented from being incorrectly received into the second inserting slots 131, and the second pins 231 are prevented from being incorrectly received into the first inserting slots 121.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A socket connector, for connecting a plug connector, comprising:
a first top plate defining a first inserting slot; and
a second top plate, substantially parallel to the first top plate, defining a second inserting slot;
wherein a distance between the first top plate and a horizontal plane of a bottom of the socket connector is greater than a distance between the second top plate and the horizontal plane.

2. The socket connector of claim 1, wherein a height of the first inserting slot is greater than a height of the second inserting slot.

3. The socket connector of claim 2, wherein a height difference between the first inserting slot and the second inserting slot is substantially equal to a height difference between the first top plate and the second top plate.

4. The socket connector of claim 1, wherein a cross section of the first inserting slot is octagonal, and a cross section of the second inserting slot is rectangular.

5. The socket connector of claim 1, further comprising a front plate connecting the first top plate and a positioning portion extending from the front plate, wherein the positioning portion comprising a sliding plane extending slantingly from the front plate, and an acute angle is defined between the sliding plane and the front plate.

6. A plug connector, for connecting a socket connector, comprising:
a first bottom wall;
a first pin secured to the first bottom wall;
a second bottom wall substantially parallel to the first bottom wall; and
a second pin secured to the second bottom wall;
wherein a distance between the first bottom wall and a horizontal plane of a bottom of the plug connector is greater than a distance between the second bottom wall and the horizontal plane.

7. The plug connector of claim 6, wherein a height of the first pin is greater than a height of the second pin.

8. The plug connector of claim 7, wherein a height difference between the first pin and the second pin is substantially equal to a height difference between the first bottom wall and the second bottom wall.

9. The plug connector of claim 6, wherein a cross section of the first inserting slot is octagonal, and a cross section of the second inserting slot is rectangular.

10. The plug connector of claim 6, further comprising a front wall connecting the first bottom wall and a latch extending from the front wall, wherein the latch comprises a latching plane, and an acute angle is defined between the latching plane and the front wall.

11. A connector assembly comprising:
a socket connector comprising a first top plate and a second top plate, the first top plate defining a first inserting slot, and the second top plate defining a second inserting slot; and
a plug connector comprising a first bottom wall, a first pin secured to the first bottom wall, a second bottom wall, and a second pin secured to the second bottom wall;
wherein a distance between the first top plate and a horizontal plane is greater than a distance between the second top plate and the horizontal plane; a distance between the first bottom wall and the horizontal plane is greater than a distance between the second bottom wall and the horizontal plane; if the first top plate faces the first bottom wall and the second top plate faces the second bottom wall, the first pin is allowed to fully inserted into the first inserting slot, and the second pin is allowed to fully inserted into the second inserting slot; if the first top plate faces the second bottom wall or the second top plate faces the first bottom wall, the first top plate abuts against the second bottom wall, blocking the first pin to be fully inserted into the second inserting slot and the second pin to be fully inserted into the first inserting slot.

12. The connector assembly of claim 11, wherein a distance between the first top plate and the second top plate is substantially equal to a distance between the first bottom wall and the second bottom wall.

13. The connector assembly of claim 12, wherein a height of the first inserting slot is greater than a height of the second inserting slot.

14. The connector assembly of claim 13, wherein a height difference between the first inserting slot and the second inserting slot is substantially equal to the distance between the first top plate and the second top plate.

15. The connector assembly of claim 11, wherein a cross section of each of the first inserting slot and the first pin is octagonal.

16. The connector assembly of claim 15, wherein a cross section of each of the second inserting slot and the second pin is rectangular.

17. The connector assembly of claim 12, wherein a height of the first pin is greater than a height of the second pin.

18. The connector assembly of claim 17, wherein a height difference between the first pin and the second pin is substantially equal to the distance between the first bottom wall and the second bottom wall.

19. The connector assembly of claim 11, wherein the socket connector further comprising a front plate connecting the first top plate and a positioning portion extending from the front plate; the plug connector further comprises a front wall connecting the first bottom wall and a latch extending from the front wall; and the latch is elastically deformable to engage with the positioning portion.

20. The connector assembly of claim 19, wherein the positioning portion comprising a sliding plane extending slantingly from the front plate, and an acute angle is defined between the sliding plane and the front plate; and the latch comprising a latching plane corresponding to the sliding plane, and an acute angle is defined between the latching plane and the front wall.
